(19) United States
(12) Patent Application Publication
(10) Pub. No.: US 2026/0299580 A1
(43) Pub. Date: Oct. 1, 2026

(54) Gimbal Emulator Assembly

(71) Applicant: John HEIMBECKER, Cibolo, TX (US)

(72) Inventor: John HEIMBECKER, Cibolo, TX (US)

(21) Appl. No.: 19/095,496

(22) Filed: Mar. 31, 2025

(51) Int. Cl. G05D 1/223; G05D 111/30; H04W 4/02; H04W 4/40; H04W 12/50

(52) U.S. Cl. CPC G05D 1/223; H04W 4/025; H04W 4/40; H04W 12/50; G05D 2111/30

(57) ABSTRACT

A gimbal emulator assembly for a non-autonomous radio-controlled mobile apparatus. The assembly accommodates an inertial measurement unit device, a contrived centering signal and a physically separated centering actuator, each for governing communications with the mobile apparatus. One or more orienting implements of the apparatus are responsive to a user's handheld orientation of the assembly and internal inertial measurement unit device. The centering-release actuator may be employed to govern a return of the orienting implement(s) to a predetermined centered position. Further, the communications governed by the assembly may be achieved in an ergonomically friendly, single-handed manner.

### BACKGROUND

Gimbals or joy sticks are often utilized in connection with video game playing or in the field of non-autonomous radio-controlled mobile apparatuses. The latter could include miniature models of boats, airplanes, cars or a variety of other miniaturized vehicles that might generally be considered radio-controlled mobile apparatuses. Within this latter field, a base unit, generally with two or more gimbals may be utilized to control the maneuvering of various model functions. For example, in the case of a mobile model aircraft, functional maneuvering may be directed with one gimbal utilized to direct a rudder and another dedicated to ailerons, an elevator or other implement functionality.

With the above in mind, the associated controlling base unit for such mobile apparatuses is generally a handheld structure that accommodates two or more gimbals for sake of controlling multiple implements of the mobile apparatus. For example, in the case of a vehicular model, one gimbal may be dedicated to controlling steering while another is dedicated to controlling thrust or breaking of the vehicle.

In addition to controlling orientation and other implement functionality, each gimbal also includes a centering default function. For example, a gimbal that is manually manipulated to control vehicle steering may be manually disengaged, or let go of, by a user's finger. This allows the gimbal to return to a centered position relative to the base unit. This automatic centering or re-centering of the gimbal may be achieved mechanically through spring driven forces within the base unit that are in interior mechanical communication with the gimbal. Staying with the example of mobile vehicle steering, releasing the gimbal to allow a return to a centered position would generally signal the wheels of the vehicle to take on a straight, non-turning profile. Similarly, in the case of a mobile boat, this default gimbal centering might return a rudder to a straight, non-turning profile as well.

Having a default automatic release for a gimbal to a centered position as described is tremendously valuable in the field of non-autonomous radio-controlled mobile apparatuses. That is, the default centering of the gimbal results in a default centering for steering in the examples above. This allows the user to also reorient perspective while using the gimbal assembly or base unit without having to break line of sight from the mobile apparatus or simply guess where the straight, non-turning orientation for the gimbal might be. Simply manually release the gimbal and an automatic return to center is achieved for the gimbal and the associated implement being signaled.

Unfortunately, while an automatic centering function is advantageous, gimbal driven control over mobile apparatuses generally involves the use of multiple gimbals. This is a function of the fact that mobile apparatuses such as those noted above will generally include multiple implements. In the case of a mobile model airplane, for example, there may be a rudder, elevator and ailerons all separately dedicated to maneuvering of the craft, not to mention one or more propellers. To make this more manageable for the user, separate implements may be controlled by a single gimbal for coordinated responsiveness to control signals. For example, the separate ailerons, one at each wing, may each be responsive to the same gimbal given the coordinated behavior generally displayed by ailerons. However, building all implement functionality into a single gimbal for such a mobile apparatus is generally impractical.

As noted above, the default centering function of the gimbal is substantially advantageous. But, as also noted above, the use of multiple manual joystick-like gimbals to control mobile apparatus maneuvering may not always be. At some point, the user is faced with any number of gimbals to manipulate but only has two hands. This doesn't even account for users facing disabilities who may only have one fully functional appendage with which to work. Once more, even envisioning a hypothetical, single gimbal base unit for a mobile apparatus having minimal implements and combined control through the single gimbal, an ergonomic challenge is still presented. That is, the user needs to manually hold the structure of the base unit and manipulate the gimbal at the same time. Depending on the setup, this may require a single hand securing the base structure while also manipulating the gimbal or one hand on the base with the other at the gimbal. Of course, the latter would be impractical for a user facing an appendage disability and regardless, this is still not ergonomically friendly even in absence of any disability. When considering that this is the circumstance for a hypothetical single gimbal base unit and that most base units accommodate multiple gimbals, the ergonomic challenges remain quite significant no matter how many working hands the user possesses.

### SUMMARY

A gimbal emulator assembly for a non-autonomous radio-controlled mobile apparatus is disclosed. The assembly includes an inertial measurement unit device that is configured for handheld orientation signal control communications with the mobile apparatus. Further, a contrived centering signal and handheld actuator are accommodated which are communicatively coupled to the inertial measurement unit device to govern the signal control communications. For example, in one embodiment, the governing by the actuator either facilitates the signal control communications or ceases the signal control communications. In an embodiment where the ceasing of communications is actuated, a return to a predetermined centered position for an implement of the mobile apparatus may be facilitated.

### BRIEF DESCRIPTION OF THE DRAWINGS

Implementations of various structure and techniques will hereafter be described with reference to the accompanying drawings. It should be understood, however, that these drawings are illustrative and not meant to limit the scope of claimed embodiments.

FIG. 1 is a profile view of an embodiment of a gimbal emulator assembly in communication with a non-autonomous mobile radio-controlled apparatus.

FIG. 2 is a side cross-sectional schematic view of an inertial measurement unit of the gimbal emulator assembly of FIG. 1.

FIG. 3 is a perspective view of the gimbal emulator assembly of FIG. 1 in a right handheld mode of operation.

FIG. 4A is a is a side view of an alternate embodiment of a mobile radio-controlled apparatus in communication with the gimbal emulator assembly of FIG. 1.

FIG. 4B is a is a side view of another alternate embodiment of a mobile radio-controlled apparatus in communication with the gimbal emulator assembly of FIG. 1.

FIG. 5 is a flow-chart summarizing an embodiment of employing the gimbal emulator assembly of FIG. 1 with a non-autonomous mobile radio-controlled apparatus.

FIG. 6 is a schematic illustration of a layout for components housed within the gimbal emulator assembly of FIG. 1.

FIG. 7 is a schematic illustrating interactions between the components of FIG. 6.

### DETAILED DESCRIPTION

Embodiments are described with reference to the use of a particular embodiment of a gimbal emulator assembly. For this embodiment, the assembly is handheld by a user with a single hand and is presented in a fairly rectangular form, perhaps resembling a large smartphone. Of course, a variety of different morphologies may be utilized, including of a two-hand variety. Further, the gimbal emulator assembly is described in terms of radio-control directed at a non-autonomous apparatus such as a mobile airplane or similar device. As used herein, terms such as “radio-controlled” are not meant to infer any particular communication or frequency parameters and the types of mobile apparatuses may extend beyond the examples illustrated. For example, the mobile apparatus could also be an ATV, helicopter, motorcycle or any other number of mobile devices. In one embodiment, the apparatus may be in the form of a graphic simulation at a video screen as opposed to being of a discrete physical form. Regardless, so long as the gimbal emulator assembly is equipped with an inertial measurement unit and a contrived centering signal for mobile apparatus orientation control and also a disassociated centering release actuator to govern this orientation control, appreciable benefit may be realized.

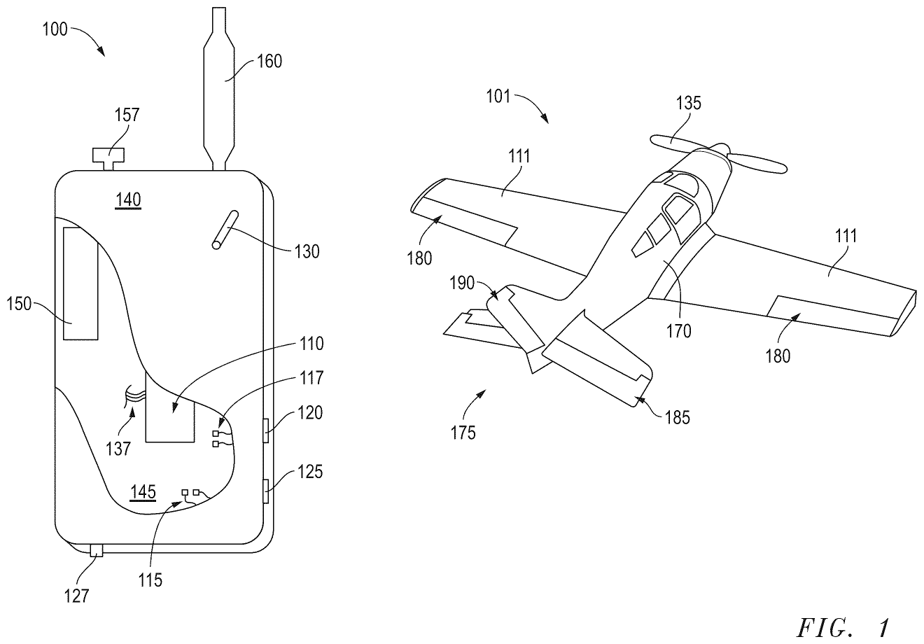

Referring now to FIG. 1, a profile view of an embodiment of a gimbal emulator assembly 100 is illustrated. The assembly 100 shown is in a roughly rectangular form with a solid, monolithic casing 140 accommodating a variety of components as described further below. The assembly 100 is configured for radio communication with a non-autonomous mobile radio-controlled apparatus 101 (e.g. see the model airplane illustrated). Unlike a conventional gimbal that might be used for radio control with such an mobile apparatus 101, the assembly 100 does not include any joystick-like protrusion for discrete manual manipulation. Instead, the assembly 100 itself is outfitted with an inertial measurement unit (IMU) 110. As opposed to a conventional IMU which may be employed at an apparatus such as the depicted plane 101 (e.g. for responsiveness to wind gusts), the IMU 110 is adapted for use by the assembly 100. Thus, the assembly 100 may be used to interrupt and/or direct orientation signals, whether to provide a counter response to ensure a corrected straight path or to reorient the apparatus 101 in flight as desired.

In one embodiment, a mode may be initiated (lock, 3D, etc.) such that the IMU 110 will respond to hand directed motion of the assembly 100 for output of a signal perceived as a correction signal. This signal may be switched away from a perpetually running IMU 110 input centering signal by way of centering-release actuators 120, 125 to steer or move implements such as the rudder 190 of the apparatus 101 away from a predetermined center. The assembly 100 may compute and direct real-time controls based thereon (e.g. note the radio board 150). These measurements may be interpreted through a combination of accelerometers and gyroscopes incorporated into the IMU 110. Further, the measurements may ultimately relate to the force, angular rate, orientation and other characteristics of the gimbal emulator assembly 100 housing the IMU 110.

While all this capacity being available through newer technology IMU's 110 as described sounds beneficial for orienting controls between a gimbal-type assembly 100 and an apparatus 101 such as the depicted model airplane 101, a challenge is also presented. Namely, with the removal of a conventional manually directed, joystick-like gimbal there is also the removal of the mechanically driven, re-centering capability afforded by a conventional gimbal.

Recall that for a non-autonomous, radio-controlled apparatus 101 such as the depicted mobile airplane, there are a variety of orientation related implements which may be in play (e.g. 180, 185, 190). More specifically, apart from wings 111, a main body 170 and a general tail 175, the apparatus 101 may include one or more propellers 135 and orientation implements, such as ailerons 180, elevators 185 and a rudder 190. While the illustrated propeller 135 may be controlled by a throttle lever 130 of the gimbal emulator assembly 100, these latter orientation implements 180, 185, 190, may be more beneficially directed through the noted IMU 110.

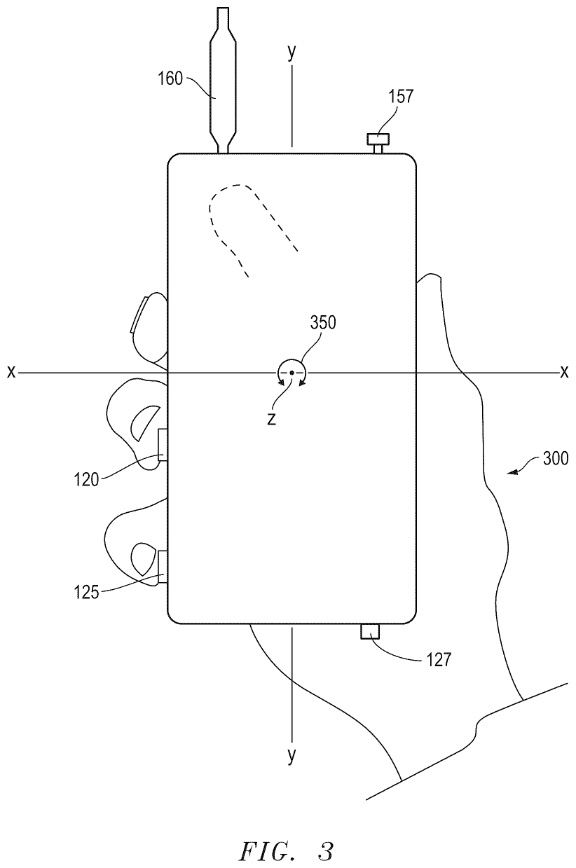

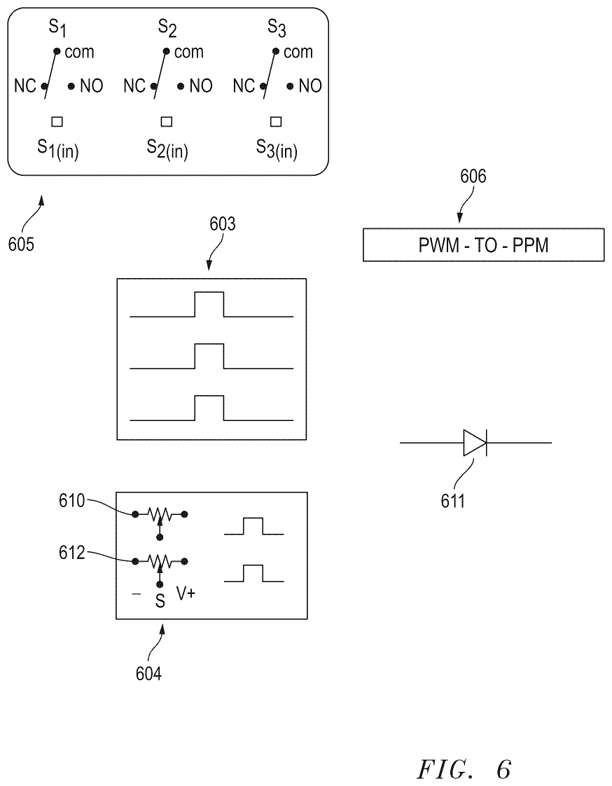

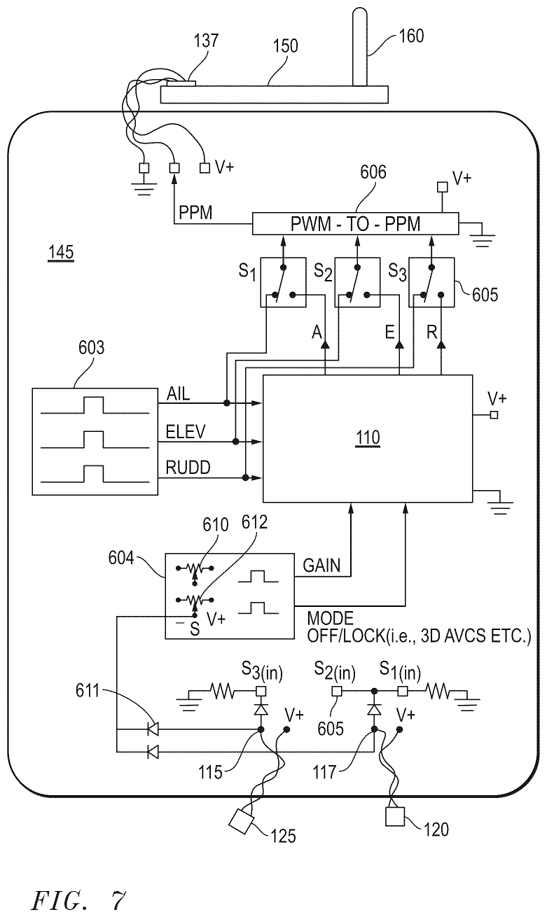

With the above in mind, a re-centering of orientation related implements 180, 185, 190 is now considered with added reference to FIG. 3. Namely, with no mechanical protruding implement or underlying spring-driven force available for re-centering, the embodiment illustrated presents a unique re-centering mode of operation for the orientation related implements 180, 185, 190. For example, consider the rudder 190. As a user might hold the gimbal emulator assembly 100 to orient the assembly 100 and direct the rudder 190 to deflect right or left by rotating the assembly 100 about its z-axis as described further below, it may be of benefit to automatically return the rudder 190 to a predetermined default center position as illustrated at FIG. 1. This may be accomplished by releasing the centering-release actuator 125 allowing the pulse generator 603 to take over (see FIGS. 6 and 7). Thus, instead of a fixed gimbal that is released from a non-center position to return to center, a “flying” IMU 110 is employed that may be returned to center by the releasing of the centering-release actuator 125 as noted.

Instead of relying on a protruding joystick that might be mechanically returned to a center position for control, the actuator 125 may be released to achieve this function. That is, while disassociating the IMU 110 orienting function from an automatic, mechanically based, re-centering might seem more cumbersome for the user's hand 300, the opposite is, in fact, true. Because the handheld emulator assembly 100 requires no finger-specific manipulation to orient the rudder 190 in the first place, the fingers of the user's hand 300 remain available for pressing of the actuator 125. This is because the mere orientation of the assembly 100 about the z-axis may already be controlling the rudder 190 position at the outset. Thus, a single hand 300 holding the assembly 100 is free to control left and right rudder 190 movements based on hand orientation relative to the z-axis which frees up finger manipulation of the actuator 125 simply by finger interaction therewith. Of course, this same concept may be extended to interaction with other actuators (e.g. 120) for sake of re-centering ailerons 180, elevators 185 or other mobile orientation related implements, all of which are described in further detail below.

Continuing with reference to FIG. 1, the gimbal emulator assembly 100 includes a conventional long-range antenna 160 for radio communication of the orientation signal outputs from the IMU 110 to the mobile apparatus 101. Of course, other signals such as the initial pairing, after powering up from a powering actuator 127, or signaling from a throttle lever 130 may also be routed through the antenna 160 and directed at the mobile apparatus 101. While a variety of different layouts may be utilized, the embodiment of FIG. 1 illustrates that the centering-release actuators 120, 125 are wired to contacts 115, 117 that are mounted on the same circuit board 145 as the IMU 110. Thus, switching communications may be supported through conventional electronics of the board 145 between the centering-release actuators 120, 125 and the IMU 110.

Continuing with reference to FIG. 1, the circuit board 145 also accommodates a separate radio board 150 for processing and routing of the noted communication signals that ultimately leave the antenna 160 as noted above. Thus, whether IMU 110 communications are of an orienting variety or altered by actuation of one of the centering-release actuators 120 or 125, as described above, the radio board 150 is available for interpretation and routing. More specifically, note the IMU wiring 137 for communications from the IMU 110 to the radio board 150, again through the circuit board 145.

For the particular embodiment illustrated, and with added reference to FIGS. 6 and 7, a gain control knob 157 along with an associated potentiometer 610 is utilized. This gain potentiometer 610 is wired to a MODE/GAIN module 604 as shown. Thus, the gain of the IMU 110 may be controlled. For example, this setup may be utilized to increase or decrease the sensitivity of the assembly 100 to hand 300 input movement. That is, the displacement, travel or deflection of an implement away from a predetermined center position may be increased or decreased relative to the corresponding movements of the assembly 100.

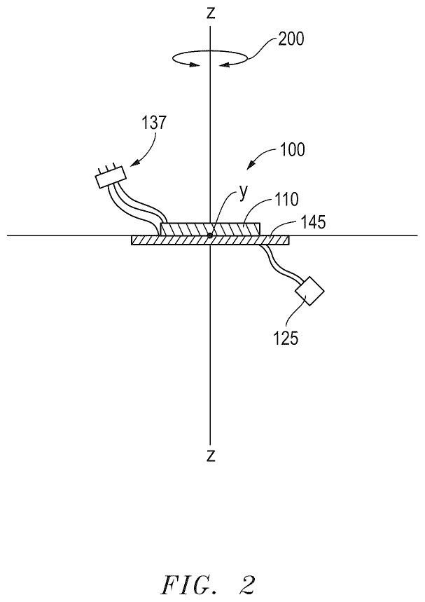

Referring now to FIG. 2, with added reference to FIG. 1, a side cross-sectional schematic view of an inertial measurement unit (IMU) 110 of the gimbal emulator assembly 100 is shown. The IMU 110 is illustrated mounted to the circuit board 145 with wiring to one of the centering actuators 125 at one end with IMU wiring 137 emerging from the other (e.g. to support communications with the radio board 150). As noted above, the functionality of the IMU 110 is one of orientation signaling, ultimately for directing implement movements at the mobile apparatus 101. More specifically, through a combination of accelerometers and gyroscopes incorporated into the IMU 110, communications may be interpreted relative to a standard three axis of rotation (e.g. X, Y and Z as shown). Recall that in the example above, movement of the assembly 100 and IMU 110, clockwise or counterclockwise about the z axis (see arrow 200) might ultimately signal the rudder 190 of the mobile apparatus plane 101 to move left or right. Of course, this might be interrupted, with the rudder 190 returning to center once the centering-release actuator 125 has been released by a user and centering generator 603 takes over as also described above.

The idea of utilizing the IMU 110 to direct orientation implements 180, 185, 190 of the mobile apparatus 101 of FIG. 1 may be extended as also noted above. For example, the ailerons 180 may be responsive to movement of the assembly 100 and IMU 110 about the y axis and the elevators 185 responsive to movement about the x axis. Of course, which particular orientation implement 180, 185, 190 is responsive to which particular axial movement might be a matter of choice, for example, with user friendliness and ergonomics in mind.

Continuing with reference to FIGS. 1 and 2, the assembly 100 and IMU 110 are described as functioning in a standard three axis mode. This is due to IMU 110 standard gyro functionality incorporated into the IMU 110 which senses rotation about the three standard axes of rotation as noted. Of course, with added accelerometer functionality built into the IMU 110, additional sliding along any axis may be sensed such that the overall orientation responsiveness may be of a six-axis variety.

Other standards may also be employed to take advantage of available off the shelf components. For example, note that the IMU wiring 137 illustrates a standard three pin terminus for the embodiment of FIG. 2. This might correspond to voltage, ground and signal inputs which are readily available in such a three-pin configuration, for example, for plugging into the circuit 145 or the radio 150 boards. Utilizing conventional standards such as plug-in pin components may be taken advantage of for sake of developing a drop-in gimbal replacement embodiment for a radio controller. That is, in place of a unitary assembly 100 as illustrated in FIG. 1, a conventional gimbal, joystick-like assembly may be reconfigured and the protruding joystick and underlying mechanical centering components removed. Such an assembly may be retrofitted with a drop-in replacement module that includes the IMU 110, centering-release actuator 125, a contrived centering signal and plug in wiring 137 as illustrated in FIG. 2.

Referring now to FIG. 3, a perspective view of the gimbal emulator assembly 100 of FIG. 1 is shown in a user's right hand 300. A version of the three-axis schematic like that of FIG. 2 is also shown. With added reference to FIG. 1, the centering-release actuators 120, 125 are now to the left of the illustration and the throttle lever 130 is no longer visible at the backside of the assembly 100, located near the user's index finger. There is the likelihood that the user is right-handed and has picked up the assembly 100 in a manner that is ergonomically comfortable with actuators 120, 125 readily pressable by the ring finger and pinky respectively. By the same token, the throttle lever 130 is now easily manipulated by the index finger. In this configuration, the thumb and middle finger may hold the majority of the weight of the assembly 100 freeing up the ring-finger and pinky for actuators 120 and 125 respectively. Notice that the throttle lever 130 has an ergonomic slant to the right ergonomically suited for a right-handed user. It may be clear at this point that left-handed users would have the same ergonomic benefit by relocating actuators 120, 125 to the opposite side and ergonomically slanting throttle 130 to the left. Indeed, in one embodiment, duplicate actuators of the same functionality may be located at the opposite side of the assembly 100 in addition to the manner illustrated here.

With added reference to FIG. 1, in contrast to a conventional gimbal assembly, for the embodiment illustrated, the orientation component of the internal IMU 110 is physically disassociated from the centering-release component of the actuators 120, 125. Nevertheless, from an ergonomic standpoint, operation of the assembly 100 is now dramatically more user friendly. This is first because the conventional protruding gimbal has been replaced with internal assembly components (e.g. the IMU 110). Thus, the assembly 100 may be stabilized merely by grasping with the hand 300 and the mobile apparatus 101 directed by orienting of the hand 300. That is, the same securing palm may both stabilize the assembly 100 and direct apparatus 101 orientation without any particular or manually discrete manipulation required by a finger. Now, as a second matter, the disassociation of the centering function away from the orienting component coincides with an enhanced level of freedom provided to the fingers, now no longer required for discrete manipulation of a protruding gimbal. In other words, fingers are now available for interacting with the newly provided and separately located centering-release actuators 120, 125. Of course, this added level of ergonomic flexibility is also of benefit to other actuators such as the noted throttle lever 130.

Continuing with reference to FIGS. 1-3, recall the example orientation movements described above. Namely, in one embodiment, movement of the hand 300 about the y axis may ultimately result in movement of the ailerons 180. For example, when looking at FIG. 3, if the thumb were to move forward relative to the page and the fingers backward to effect rotation about the y axis, the aileron 180 might deflect up whereas the opposite rotation of the assembly 100 about the y axis might direct the aileron down to roll the plane apparatus 101 clockwise or counterclockwise as the case may be. Use of the IMU 110 of the assembly 100 to achieve orientation implement movement in this manner can be extended to the other axes (x and z) as well. For example, rotating the assembly 100 and hand 300 clockwise or counterclockwise about the z axis (see arrow 350) might translate to movement of the rudder 190 to yaw the plane apparatus 101 clockwise or counterclockwise. Further, rotating the assembly 100 forward or backward about the x axis might affect movement of the elevators 185 up or down to pitch the plane apparatus 101 up or down. Of course, tying these particular assembly 100 movements about the axes (x, y and z) to particular orientation implement movements at the mobile apparatus 101, is only exemplary. Any number of correlations between assembly orientations and orientation implement movements may be effectively employed so long as the assembly 100 is equipped with the IMU 110 as described.

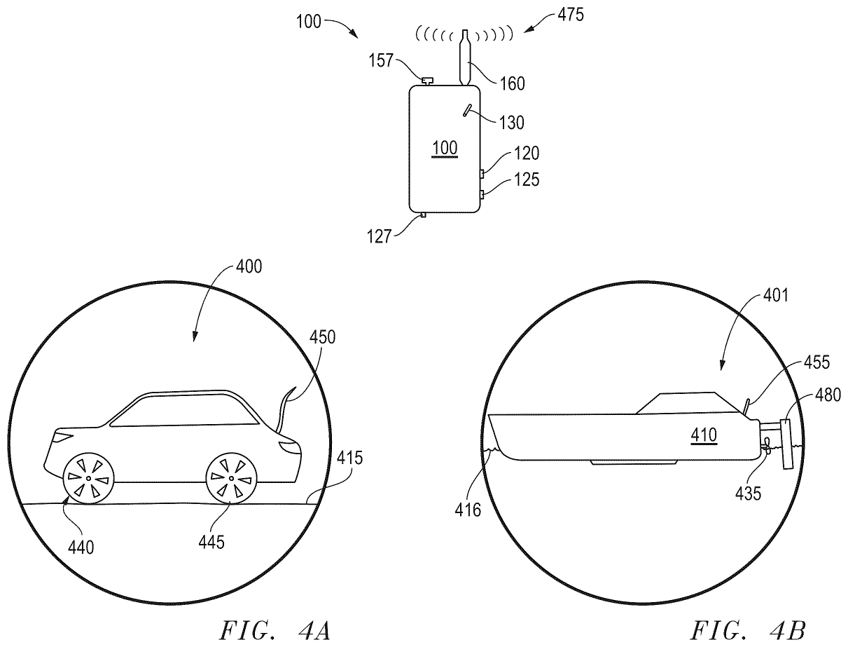

Referring now to FIGS. 4A and 4B, the gimbal emulator assembly 100 is illustrated. The assembly 100 may be utilized as described above for radio control communications with a mobile apparatus 101 in the form a miniature plane as illustrated in FIG. 1. However, other versions of a mobile apparatus may also be controlled by the assembly 100. This may include miniature mobile helicopters, motorcycles, all terrain vehicles or a car 400 as shown in FIG. 4A or a boat 401 as shown in FIG. 4B.

With specific reference to FIG. 4A, the orienting elements may be front wheels 440. So, for example, movement of the assembly 100 as described above may be employed for steering of the front wheels 440 as communicated through radio signaling (see 475) to a receiving antenna 450 of the car 400. Thus, with rear wheels 445 providing car movement and/or acceleration along the ground 415, the user may orient the assembly 100 to turn the front wheels 440 as desired, for example, to correspond with a turn at a track along the ground 415. Of course, following turning, the front wheels 440 may be quickly returned to a straightened alignment by releasing of a corresponding centering-release actuator (120 or 125).

With specific reference to FIG. 4B, another alternate embodiment of a mobile radio-controlled apparatus is shown in the form of a boat 401 as indicated. In this case, the orienting implement is a rudder 480 in communication with the gimbal emulator assembly 100 by way of another antenna 455. Thus, the body 410 of the boat 401 may be steered along the water surface 416 as illustrated. Again, once steering through a given turn is complete, the rudder 480 may be quickly returned to center by releasing one of the centering-release actuators 120, 125 of the assembly 100.

With added reference to FIG. 1, note that just like the plane propeller 135 of FIG. 1, the alternate embodiment mobile apparatuses of FIGS. 4A and 4B, both include a manner of propulsion that is not necessarily orienting in nature. More specifically, the rear wheels 445 of FIG. 4A and the boat propeller 435 of FIG. 4B may perform this function for these apparatuses 400, 401. For the embodiments shown, the assembly 100 is equipped with a throttle lever 130 to govern this propulsion and/or acceleration/deceleration of the apparatuses 400, 401. However, in alternate embodiments, the assembly 100 and internal IMU 110 may be configured to allow for user axial movements to govern speed as well. That is, unlike a plane or helicopter, apparatuses 400, 401 of FIGS. 4A and 4B are supported by the ground 415 or a water 416 surface. Thus, fewer orienting implements may be at issue (e.g. limited to front wheels 440 or a boat rudder 480 in the illustrated examples here). Therefore, as a matter of user or designer preference, other functionality, such as throttling, may be built into the assembly 100 and IMU 110. This may allow for avoidance of throttle lever 130 manipulation by the user in accelerating or slowing the apparatuses 400, 401 which may be of ergonomic preference.

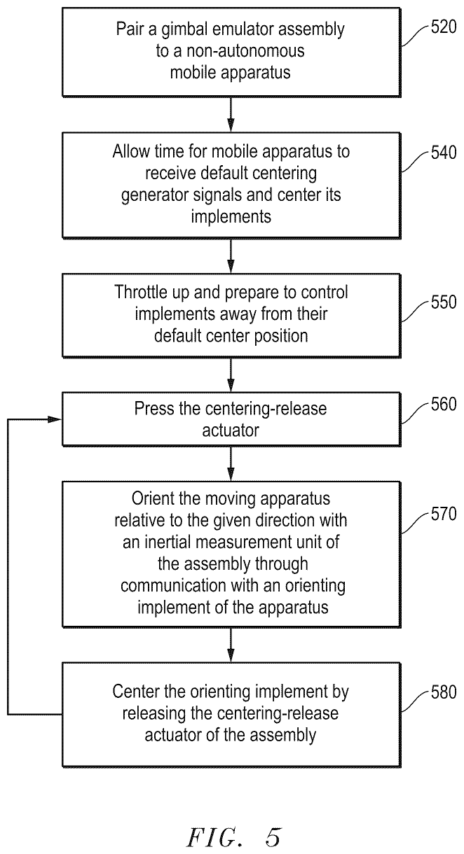

Referring now to FIG. 5, with added reference to FIG. 1, a flow-chart is shown summarizing an embodiment of employing the gimbal emulator assembly 100 with a non-autonomous mobile radio-controlled apparatus 101. With the above in mind, the assembly 100 is communicatively paired with the apparatus 101 as noted at 520. So, for example, with the plane apparatus 101 turned on, the powering actuator 127 of the assembly 100 may be pressed to initiate assembly powering and dedicated radio-controlled communications between the assembly 100 and apparatus 101.

With communications established, the plane 101 or any other apparatus type may receive a default signal to center its implements as indicated at 540. So, for example, the plane apparatus 101 may straighten its rudder, level its ailerons, center its nose wheel and level its elevator. With continuing reference to FIG. 1, the throttle lever 130 may be advanced as indicated in 550 and movement along a ground surface may take place in preparation for takeoff. However, to achieve takeoff, strategic movement of the gimbal emulator assembly 100 may next be employed, so long as centering-release actuator 120 125 is pressed as indicated in 560. This may include movement of the IMU 110 equipped assembly 100 in orientations relative to a variety of axes (e.g. x, y and z as described above). These single-hand movements of the assembly 100 by the user may be undertaken to position orienting implements such as elevators 185 or ailerons 180 for takeoff. In other words, the moving plane apparatus 101 may be oriented or reoriented relative to the initial given direction of simply advancing forward along the ground surface (see 570).

Continuing with the present example, the plane apparatus 101 now in flight, might continue to be oriented and reoriented by the user's single-hand supported movements of the assembly 100 relative the axes (x, y and z as noted above). For example, a rudder 190 might be deflected left or right by clockwise or counterclockwise movements of the assembly 100 about a z axis as directed by the user to attain left or right movement of the plane apparatus 101 in flight. Of course, the same may be true for turning front wheels 440 of a car apparatus 400 as noted above (e.g. see FIG. 4A). Indeed, as detailed above, any number of orienting implements may be single-handedly directed by a user in free form without the need for discrete manual manipulation of a joystick as might be found on a conventional gimbal assembly.

Continuing with reference to FIG. 5, guiding of a non-autonomous mobile apparatus also inherently benefits from being able to quickly re-center orienting implements. So, in keeping with the mobile apparatus example of a radio-controlled plane 101, returning a previously left or right deflected rudder 190 to center position in an automatic manner may be of benefit for the user. As indicated at 580, this may be achieved by separate manual interaction with a centering-release actuator 120 or 125 of the assembly 100. Furthermore, following a centering, continued operation of the apparatus 101 would often return the user to employ the assembly 100 in continuing to orient the apparatus 101 (e.g. returning to 560 as illustrated).

Note that the fingers of the user are now freed up due to the nature of the assembly 100 with incorporated IMU 110. Once more, employing a finger to interact with a separated or physically disassociated centering-release actuator 120 or 125 does not present any instability to the handheld assembly 100 (e.g. see FIG. 3). That is, moving a finger about the accommodated assembly 100 to reach a centering-release actuator 120 or 125 does not compromise the holding of the assembly 100 in any material manner because the primary holding is likely achieved by the thumb and middle finger. Thus, unlike a conventional joystick based gimbal assembly, a single hand may be more than sufficient to control both orientations and re-centering in a manner not previously available in the field. While this is particularly beneficial for users that might be disabled or compromised in terms of two-handed capabilities, this also presents a more ergonomic and user-friendly gimbal assembly regardless of any differently abled issue that might be in play.

Referring now to FIG. 6, with added reference to FIG. 1 and FIG. 2, specific components used in the above particular embodiment of a gimbal emulator assembly 100 are now described. Analog switch 605 is generally known to those skilled in the art as an effective way to transfer communication data. The S1, S2 and S3 switches are actuated by signals arriving at S1(in), S2(in) and S3(in). That is, when actuated the normally closed (NC) switch path to common (COM) flips to the normally open (NO) position and the signal path now passes from (NO) to (COM). The PWM-To-PPM converter module 606 is used to convert a servo-signal (PWM) into a transmittable single-wire (PPM) transmit-module input. Generally, a transmit-module 150 may receive a PPM (Pulse Position Modulation) input. The IMU 110 outputs PWM (Pulse Width Modulation) servo signals, as it is intended to be installed in a non-autonomous mobile radio-controlled apparatus 101 (e.g. see the model airplane illustrated). Therefore, signal conversion is required. The three channel CENTERING pulse generator 603 outputs three perpetually running pulse-trains. In this case, these pulses have a CENTER-WIDTH of 1.5 mS. Therefore, the IMU 110 may interpret these signals as if an on-board airplane receiver had sent CENTERING signals to it. The MODE/GAIN module 604 is used to convert a voltage input into a PWM signal. Thus, the IMU 110 may receive these MODE and GAIN control-signals, as if an on-board airplane receiver had sent them to it. GAIN potentiometer 610 is wired to the MODE/GAIN module 604 as shown. It is used to vary the pulse width delivered to IMU 110 GAIN input control. MODE potentiometer 612 is fixed and wired to the MODE/GAIN module 604 as well. It is used to set and default the MODE control of IMU 110 to normally OFF. Therefore, CENTERING signals from generator 603 may pass through. Further, whether they pass through IMU 110 or not, they provide a CENTERING reference with which the IMU 110 may INITIALIZE from each and every time actuators 120, 125 are pressed and the MODE is switched to LOCK MODE. (3D, Atti. Etc.) Diodes 611 are of the generic 1N914 variety. In this assembly, these diodes communicatively couple centering-release actuators 120 and 125 to the MODE input of module 604 in order to change the MODE of IMU 110 from OFF to LOCK (or 3D-MODE etc.) while at the same time flipping switches 605 to allow IMU 110 output.

Referring now to FIG. 7, with added reference to FIGS. 1, 2, 5 and 6. A detailed explanation of the interaction between the key components is now presented for clarity. Beginning with a pairing as in 520, the next step in the flow chart is 540. Here, a contrived centering signal is initiated. This CENTERING signal is generated by a perpetually running CENTERING pulse generator 603. First, notice that the three CENTERED axes AIL, ELEV and RUDD are always in communication with IMU 110 so that they may provide a CENTERING reference with which the IMU 110 may INITIALIZE each and every time centering-release actuators 120, 125 are pressed. That is, a reference to steer or move away from CENTER (a release from centering) is established. Second, notice that by default switch 605 passes this contrived centering signal through to converter 606, on to radio board 150 via connector 137 and out antenna 160. Thus, 540 from the flow chart in FIG. 5 is satisfied. Now, assume 550 (a throttle up) has occurred. The next step is indicated in 560. The centering-release actuators 120 and 125 are communicatively coupled to the inertial measurement unit 110 via the MODE/GAIN module 604. Further, they are coupled to switches 605. Now, two very important things occur. First, the MODE control of IMU 110 is switched from OFF to LOCK or 3D-MODE. Second, switches 605 pass through signals A, E and R to module 606 and on out the chain to the antenna 160. NOTICE, at this point, signals A, E and R are CORRECTION signals normally intended for implement correction against wind gusts etc. Here, they are instead used to move or steer the implements of a non-autonomous apparatus such as apparatus 101 AWAY FROM THE CENTER that has been contrived with centering pulse generator 603 satisfying 560. Now, with reference to 570, orienting the moving apparatus relative to the given direction with IMU 110 through communication with orienting implements of the apparatus is underway. Finally, with reference to 580, centering the orienting implement by releasing the centering-release actuator of the assembly may occur at any time. In doing so, the MODE is returned to OFF and switches 605 flip back to their default position allowing the contrived centering signal from generator 603 to exit the chain out through antenna 160 and CENTER implements. A return to 560 for orienting and 580 for centering is regular and frequent.

Embodiments described hereinabove include an assembly that emulates gimbal functionality when communicatively paired with a non-autonomous apparatus such as a radio-controlled mobile car or aircraft. However, unlike a conventional gimbal setup, simultaneous physical control over a base unit and a joystick is no longer required. Instead, an assembly is provided where the physical joystick is eliminated and the remaining recentering functionality is moved to one or more centering-release actuators. This results in a physical disassociation of the orienting and centering functions. Nevertheless, this disassociation is facilitated by an internal IMU that requires no discrete, finger-driven control, thereby freeing up fingers for interaction with the actuators. Thus, without any compromise to functionality, a gimbal emulator assembly is provided that may be operated in an ergonomically superior, single-handed manner.

The preceding description has been presented with reference to presently preferred embodiments. Persons skilled in the art and technology to which these embodiments pertain will appreciate that alterations and changes in the described structures and methods of operation may be practiced without meaningfully departing from the principle, and scope of these embodiments. For example, the embodiments described hereinabove include the use of one or more centering-release actuators that may be manually released to ultimately return orienting implements of a mobile apparatus to a predetermined center position. Of course, the opposite could be the case where centering is facilitated instead by manual pressing of an actuator. Furthermore, the foregoing description should not be read as pertaining only to the precise structures described and shown in the accompanying drawings, but rather should be read as consistent with and as support for the following claims, which are to have their fullest and fairest scope.

I claim:

1. A gimbal emulator assembly for a non-autonomous radio-controlled mobile apparatus, the gimbal emulator assembly comprising:
an inertial measurement unit device for handheld orientation signal control communications with the apparatus; and
a centering actuator communicatively coupled to the inertial measurement unit device for governing the signal control communications.

2. The gimbal emulator assembly of claim 1 wherein the governing comprises one of facilitating the signal control communications and ceasing the signal control communications.

3. The gimbal emulator assembly of claim 2 wherein the ceasing of the communications facilitates a return to a predetermined centered position for at least one implement of the mobile apparatus.

4. The gimbal emulator assembly of claim 1 wherein the inertial measurement unit device is physically disassociated from the centering actuator.

5. The gimbal emulator assembly of claim 1 wherein the inertial measurement unit device and the centering actuator are accommodated by a monolithic casing.

6. The gimbal emulator assembly of claim 5 wherein the casing accommodates a throttle lever to govern speed communications with the apparatus.

7. The gimbal emulator assembly of claim 1 wherein the inertial measurement unit device and the centering actuator are configured as a unitary drop-in replacement module for a radio controller.

8. A radio control system comprising:
a non-autonomous radio-controlled mobile apparatus with at least one orienting implement; and
a gimbal emulator assembly with an inertial measurement unit device and a physically disassociated centering actuator, the device and the actuator to govern movement of the implement.

9. The system of claim 8 wherein the apparatus is in the form of one of a model airplane, a car, a boat, an all-terrain vehicle, a helicopter, a motorcycle and a graphic simulation.

10. The system of claim 9 wherein the orienting implement comprises one of a rudder, an elevator, ailerons and at least one front wheel.

11. A method of controlling a non-autonomous mobile apparatus, the method comprising:
pairing communications between the apparatus and a gimbal emulator assembly with an inertial measurement unit device;
directing movement of the apparatus in a given direction with the assembly; and orienting the moving apparatus with the assembly based on the communications between the apparatus and the inertial measurement unit device.

12. The method of claim 11 wherein the orienting comprises governing movement of an orienting implement of the apparatus by handheld orienting of the assembly.

13. The method of claim 12 wherein the orienting implement comprises one of a rudder, an elevator, ailerons and at least one front wheel.

14. The method of claim 12 wherein the handheld orienting is achieved by single-handed accommodation of the assembly by a user.

15. The method of claim 14 further comprising returning the orienting implement to a predetermined center position by manipulation of a centering actuator with a finger of the user during the single-handed accommodation.

16. The method of claim 12 wherein the inertial measurement unit device employs one of a gyroscope and an accelerometer for measurements related to one of force, angular rate and orientation of the assembly.

17. The method of claim 16 wherein the gyroscope facilitates a three axis of rotation mode of control by the assembly over the orienting implement.

18. The method of claim 17 wherein the accelerometer facilitates a six axis of rotation mode of control by the assembly over the orienting implement.

19. The method of claim 11 wherein the directing of the movement of the apparatus in a given direction is facilitated by a discretely provided throttle lever of the assembly.

20. The method of claim 12 wherein the directing of the movement of the apparatus in a given direction is facilitated by the handheld orienting of the assembly.
